(19) United States
(12) Patent Application Publication
(10) Pub. No.: US 2011/0074144 A1
(43) Pub. Date: Mar. 31, 2011

(54) PAGE DISPLAY AND ORGANIZER

(76) Inventor: DONNA J. DELL'ORFANO, Boulder City, NV (US)

(21) Appl. No.: 12/893,995

(22) Filed: Sep. 29, 2010

Related U.S. Application Data
(60) Provisional application No. 61/246,532, filed on Sep. 29, 2009.

(51) Int. Cl. B42D 13/00

(52) U.S. Cl. 281/38

(57) ABSTRACT

A page display and organizer is comprised of a page protector, at least one tab adjoined to the page protector, and a binding member. The transparent page protector includes a first edge attached to the binding member, second edge, third edge, fourth edge and a first layer and second layer that is connected to one another along the first edge, third edge, and fourth edge. The first layer and second layer form an opening along the second edge for page insertion. The at least one tab is attached to the second edge and/or to the third edge of the page protector and may include adhesive, magnet, or VELCRO®. The user displays a page by inserting a page into the page protector opening and attaching the tab to a surface The user can later store the page while still inside the page protector by binding it into a suitable storage unit.

This application claims the benefit of priority under 35 U.S.C. §119 of provisional application Ser. No. 61/246,532, filed Sep. 29, 2009, the contents of which are hereby incorporated by reference.

### FIELD OF THE INVENTION

The present invention generally relates to organizational products. More particularly, the present invention relates to a device used to display and organize pages.

### BACKGROUND

People often display an array of items such as photographs, important documents, and their children's art on surfaces such as refrigerators, bulletin boards, or even on bare walls. Such displays (such as those found on refrigerators) often result in clutter and disorder as such items are often jumbled with a hodgepodge of other less appealing objects like recipes, take-out menus, billing statements, coupons, notes and reminders, ticket stubs, magazine cut-outs, an assortment of magnets, and other miscellaneous items.

After some of these items are displayed (e.g., important documents, photographs, souvenirs, and children's art, report cards, school assignments, certificates, and other achievements), it is often desirable to save these items in an efficient, simple, and organized manner for later reference or as mementos. Such a need in the art can be categorized into home, school, office and workplace, and retail contexts.

For instance, after children come home from school or daycare, children often present to their parents or caregivers their class photographs, artwork, report cards, graded school assignments, certificates, honors, and other achievements. Parents often display such items on a refrigerator or perhaps in some other designated area of the house such as a bulletin board. While these items are displayed, they often become damaged, wrinkled and folded at the edges and corners, stained, faded and discolored from sunlight, or may simply fall off from the surface to which they are attached. After displaying these items, parents usually want to save them as souvenirs and mementos and as a result, they may place these items into a box, a drawer, or other storage unit (and later forget about these items), or if the parent has ample time on their hands, they may embark on the timely task of organizing and scrapbooking, or storing it away in some photo album in an organized manner. Even those without children may want to display and easily store important documents, certain achievements, and photographs. Not only are these items that are displayed subject to damage as they are unprotected from sunlight, water, stains, wrinkling, and folding, it is a burden to embark on the arduous task of later organizing and scrapbooking or placing these pages in photo albums or in some other organized medium.

In a school context, teachers often display their students' photographs, assignments, and artwork on bulletin boards. As discussed above in the home context, these items that are displayed often become damaged, wrinkled and folded at the edges and corners, stained, or faded and discolored from sunlight. Furthermore, these items may be subject to student tampering and are thus subject to even further damage. After a teacher displays such items, the teacher may want to later store these items for later reference. For example, if a teacher is conducting an open-house where parents come to visit and learn about their child's progress, a bulletin board may only showcase a limited number of items, and the teacher may also want to show parents items that were previously displayed in an organized and professional manner. Additionally, a teacher may want to keep a file or create a compilation of assignments, artwork, photographs, and achievements for each student or a compilation of model assignments on a particular subject matter. At the end of the year or term, the teacher may then want to easily provide parents of each student a compilation of their student's achievements comprised of assignments, artwork, certificates and awards, photographs, etc. Further, a teacher may want to provide some type of protection for a student's assignment, artwork, certificate, or other achievement during transport to the student's home while at the same time offer an efficient way for the parents to easily display and/or store the student's achievements.

In an office or workplace context, memoranda and announcements are often posted onto bulletin boards in common areas. These announcements may include original documents and correspondence or photographs of new employees, newly born babies, employees of the month, etc. After these documents, memoranda, announcements, and photographs are displayed, the office manager may later want to quickly store and organize these items for later reference, while protecting these items at the same time. For example, the office manager may want to maintain a compilation of photographs of employees-of-the-month or a compilation of all original correspondence regarding customer service. Employees may also want to display and protect certain documents (or even personal items such as photos or their children's artwork) in their office and may want the option to later quickly, easily and securely store such documents and items into one unit (such as a binder) without the hassle of having to remove the items from the page protector, organizing such items, and placing each of these items into another medium such as a separate album.

In another aspect, certain types of jobs may require displaying documents in connection with presentations. For example, a presenter may want to post a series of documents showing certain data and may also want to reuse the same series of documents for another presentation. After multiple uses, these presentation documents may become worn and damaged. Thus, it would be ideal to have a solution wherein the presenter can quickly post and display documents during a presentation and then can promptly organize and store these documents for later use, while at the same time preserving the documents.

In a retail context, retailers may utilize page protectors to protect and display weekly circulars of sale items, flyers, and announcements. Retailers may also utilize embodiments of the invention comprised of smaller-sized page protectors such as those that can accommodate sales tags and signs. In such embodiments, the smaller-sized page protectors can attach to the underside or any suitable location of shelf fronts by magnets, VELCRO®, or removable adhesive. Retailers may also exhibit goods for sale using photographs, especially where the goods for sale are one-of-a-kind items or high-valued goods. Some retailers may not want to exhibit the goods as they can be tampered with but at the same time would like to show close-up views of the goods to show details and features. Sometimes locked display boxes or cases may not be ideal in showcasing the goods' details and features, may be too expensive, or may not be completely secure from potential thieves. Retailers may want to exhibit documents describing the goods specifications and features and photographs of their goods and may later want to organize and compile such documents and photographs for later reference or for customer viewing.

While page protectors may protect pages of a documents or photograph from damage and fading, none fulfill all of the needs discussed above since page protectors are not specifically adapted to be displayed as they are usually adapted to be stored in a certain type of binder. A page protector with contents therein can be hung for display; however, sticking a thumbtack or pushpin through a page protector would damage the page protector and possibly the contents therein. Furthermore, using adhesive methods such as tape can also damage the page protector since many adhesives are not completely removable and often leave a residue behind. Page protectors are ideal for binders but are not necessarily ideal for displaying. Furthermore, page protectors are generally limited as they are typically adapted for use for standard three-hole binders and usually cannot be used in a wide variety of scrapbooks, photo albums, and other binders.

Therefore, there is a need in the art for a device that (a) allows documents and photographs to be displayed, (b) protects documents and photographs from damage due to sunlight, liquids, stains, wrinkling, and folding, and (c) provides an efficient way to easily and quickly store and organize such documents and photographs for later reference and viewing. The present invention addresses the foregoing need in the art as it allows displaying while protecting the documents or photograph and avoids the arduous task of later having to organize, store, and scrapbook or having to place these pages into photo albums or into some other storage medium in an organized manner. Other advantages of the present invention will be apparent to one of ordinary skill in the art in light of the ensuing description of the present invention.

### SUMMARY

The present invention provides a device that (a) allows documents and photographs to be displayed, (b) protects documents and photographs from damage due to sunlight, liquids, stains, wrinkling, and folding, and (c) provides an efficient way to easily and quickly store and organize such documents and photographs for later reference and viewing. Such a device addresses needs in home, school, office and workplace, and retail contexts and saves users time by not having to later embark on the arduous task of organizing, storing, and scrapbooking or to place these pages into photo albums or into some other storage medium in an organized manner.

To achieve the foregoing and in accordance with the purposes of the present invention, the present invention is generally directed to a page display and organizer comprised of: (a) a page protector, (b) at least one tab adjoined to the page protector wherein the at least one tab attaches the page protector to a surface for display; and (c) a binding member attached to the first edge wherein the binding member binds the page protector into a storage unit. The page protector includes a first edge, a second edge, a third edge, a fourth edge, a first layer, a second layer, and an opening along the second edge. The first layer is connected to the second layer along the first edge, the third edge, and the fourth edge. The opening along the second edge is formed by the first layer not being connected to the second layer along the second edge. A page of a document or photo may be inserted through the opening into the page protector.

The at least one tab may comprise an adhesive, magnet, or a hook and loop fastening system such as VELCRO® to permit attachment of the page protector to a surface for display. The at least one tab may include a perforation along the page protector wherein the perforation allows the at least one tab to be detached from the page protector. The at least one tab may be adjoined to the second edge of the page protector, or in other variations of the invention, it may be adjoined to the third edge of the page protector.

The user displays a page by inserting a page into the opening of the page protector, attaching the at least one tab of the page protector to a surface such as a wall, refrigerator, or bulletin board, and the user can later store the page while still in the page protector by binding it into a storage unit such as a scrapbook, photo album, or any suitable booklet or binder. Before binding the page protector into the storage unit, the user may choose to detach the tab which is detachable via perforation in some embodiments, or the tab can be cut off.

In another embodiment of the invention, a page display and organizer is comprised of: (a) a page protector that includes a first edge, a second edge, a third edge, a fourth edge, a first layer, a second layer, and an opening, (b) a plurality of removable tabs adjoined to the page protector wherein the plurality of removable tabs attach the page protector to a surface for display; and (c) a binding member attached to the first edge wherein the binding member binds the page protector into a storage unit. The first layer is connected to the second layer along the first edge, the third edge, and the fourth edge of the page protector, and the opening along the second edge of the page protector is formed by the first layer not being connected to the second layer along the second edge. A page of a document or photo may be inserted through the opening along the second edge into the page protector.

The plurality of removable tabs may include a perforation along the page protector. The perforation allows the plurality of removable tabs to be detached from the page protector before the page protector is to be stored in a suitable storage unit. The plurality of removable tabs may be comprised of a first tab adjoined along the second edge of the page protector and a second tab adjoined along the third edge of the page protector. Alternatively, the plurality of removable tabs may be comprised of a first tab and a second tab wherein the first tab and the second tab are adjoined along the second edge of the page protector, and the plurality of removable tabs may further include a third tab and a fourth tab wherein the third tab and the fourth tab are adjoined along the third edge of the page protector.

Another aspect of the present invention is directed to a system to display and organize pages comprising: (a) a page display and organizer comprising: (i) a page protector comprised of a first edge, a second edge, a third edge, a fourth edge, a first layer and a second layer wherein the first layer is connected to the second layer along the first edge, the third edge, and the fourth edge, and an opening along the second edge wherein the opening is formed by the first layer not being connected to the second layer along the second edge and wherein a page may be inserted through the opening into the page protector; (ii) at least one tab adjoined to the page protector wherein the at least one tab attaches the page protector to a surface for display, (iii) a binding member attached to the first edge; and (b) a storage unit adapted to receive and hold the page display and organizer. The binding member binds the page protector into the storage unit, and the storage unit can hold a plurality of page display and organizers. The at least one tab may include an adhesive, magnet, or a hook and loop fastening system such as VELCRO® to permit attachment of the page protector to a surface for display. The at least one tab may comprise a perforation along the page protector wherein the perforation allows the at least one tab to be detached from the page protector.

The binding member may comprise of a hook and loop fastening system. For instance, the system to display and organize pages of the present invention may further comprise a hook and loop fastening system wherein the binding member comprises a hook fastening component and the storage unit comprises a loop fastening component. Alternatively, the binding member may include a plurality of apertures and the storage unit may be comprised of a binder that includes a quantity of rings wherein the quantity of rings is equal to the plurality of apertures.

The above description sets forth a summary of embodiments of the present invention so that the description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in further detail, it is to be understood that the invention is not limited in its application to the details of the construction and to the arrangement of the components set forth in the following description or as illustrated in the drawings. The invention is capable of other embodiments and of being practiced and carried out in various ways. Furthermore, it is to be understood that the phraseology and terminology employed herein are for the purpose of description and should not be regarded as limiting.

Other features, aspects, and advantages of the present invention will become apparent from the following description of the invention, taken in conjunction with the accompanying drawings, which illustrate, by way of example, various features of embodiments of the invention.

### BRIEF DESCRIPTION OF THE DRAWINGS

FIG. 1 depicts a front view of a page display and organizer in accordance with an embodiment of the present invention.

FIG. 1A. depicts a front view of a page display and organizer in accordance with an embodiment of the present invention.

FIG. 2. depicts a front view of a page display and organizer in accordance with an embodiment of the present invention.

FIG. 3. depicts a front view of a page display and organizer in accordance with an embodiment of the present invention.

FIG. 4A depicts a cross-sectional view along the second edge of a page display and organizer in accordance with an embodiment of the present invention.

FIG. 4B depicts a cross-sectional view along the second edge of a page display and organizer in accordance with an embodiment of the present invention.

FIG. 5A depicts a front view of a page display and organizer in accordance with an embodiment of the present invention.

FIG. 5B depicts a front view of a page display and organizer in accordance with an embodiment of the present invention.

FIG. 5C depicts a front view of a page display and organizer in accordance with an embodiment of the present invention.

FIG. 5D depicts a front view of a page display and organizer in accordance with an embodiment of the present invention.

FIG. 6A depicts a front view of a binding member of a page display and organizer in accordance with an embodiment of the present invention.

FIG. 6B depicts a front view of a binding member of a page display and organizer in accordance with an embodiment of the present invention.

FIG. 6C depicts a front view of a binding member of a page display and organizer in accordance with an embodiment of the present invention.

FIG. 6D depicts a front view of a binding member of a page display and organizer in accordance with an embodiment of the present invention.

FIG. 6E depicts a front view of a binding member of a page display and organizer in accordance with an embodiment of the present invention.

### DESCRIPTION OF THE INVENTION

In the following description of embodiments of the invention, reference is made to the accompanying drawings, which form a part of this application. The drawings show, by way of illustration, certain embodiments in which the invention may be practiced. It is to be understood that other embodiments may be utilized and modifications may be made without departing from the scope of the present invention. Also, it is to be understood that the phraseology and terminology employed herein are for the purpose of description and should not be regarded as limiting.

For ease of reference, the following reference numbers are consistently used in the figures of the present application to depict various components and embodiments of the present invention.

### REFERENCE NUMBERS

100 page protector
101 first edge of page protector
102 second edge of page protector
103 third edge of page protector
104 fourth edge of page protector
110 first layer of page protector
120 second layer of page protector
150 opening of page protector
200 the at least one tab
201 first tab
202 second tab
203 third tab
204 fourth tab
300 binding member
301 first aperture of binding member
302 second aperture of binding member
303 third aperture of binding member
310 first binding member
320 second binding member
330 third binding member

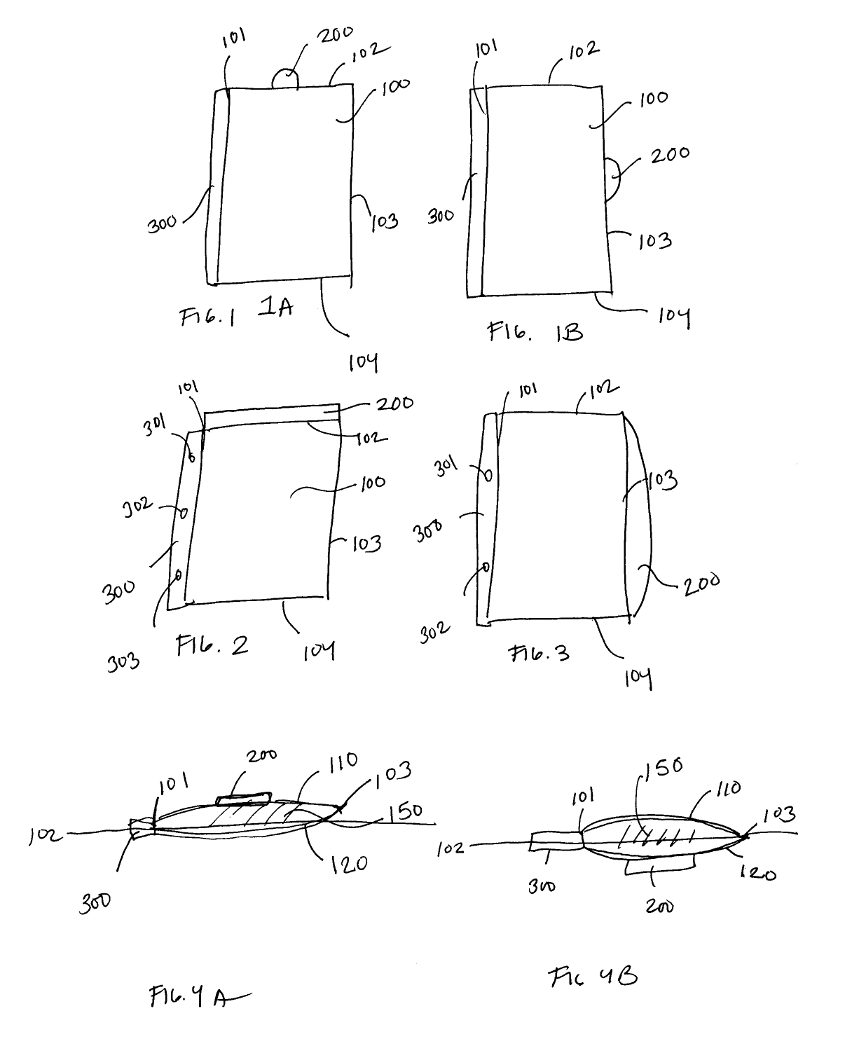

FIGS. 1A, 1B, 2, and 3 illustrate a front view of a page display and organizer of the present invention which is comprised of a transparent page protector 100, at least one tab 200 on the page protector 100, and a binding member 300. Page protector 100 includes a first edge 101 that includes binding member 300, a second edge 102, a third edge 103, and a fourth edge 104. In the embodiments shown in the accompanying drawings, binding member 300 is attached to first edge 101 of page protector 100, and second edge 102 includes the opening through which the document or item is inserted inside page protector 100 such that second edge 102 is generally the top edge for documents displayed in the portrait orientation. Third edge 103 is generally the edge of page protector 100 that is positioned opposite first edge 101 which is attached to binding member 300. Fourth edge 104 is generally the edge of page protector 100 that is positioned opposite of second edge 102.

Attachment Tab

Tab 200 may be attached to second edge 102 as seen in FIG. 1A. In another embodiment of the present invention, tab 200 may be attached to third edge 103 of page protector 100 as seen in FIG. 1B. For embodiments of the invention wherein users desire to display portrait-oriented pages, users would use the embodiments shown in FIGS. 1A, 2, and 5A, and wherein users desire to display landscaped-oriented pages, users would use the embodiments shown in FIGS. 1B, 3, and 5B. Tab 200 may be positioned anywhere along either or both second edge 102 and third edge 103 so long as it permits attachment of page protector 100 to a surface.

Tab 200 may be of any appropriate size and shape so long as it provides sufficient surface area to permit attachment of page protector 100 to any suitable surface. For instance, as seen in FIGS. 1A and 1B, tab 200 may be sized and shaped similar to a portion of a half dollar coin. In such embodiments, tab 200 is easily detachable before storage and organization of the page displayed. Furthermore, tab 200 may be rectangular in shape and may be positioned along a portion of second edge 102 or the entire length of second edge 102 as shown in FIG. 2. Alternatively, rectangular tab 200 may be positioned on third edge 103 of page protector 100. In another embodiment of the invention, tab 200 may include a curvature as illustrated in FIG. 3. In such embodiments, tab 200 may comprise a portion of third edge 103 or the entire length of third edge 103 as seen in FIG. 3. Alternatively, curved tab 200 may be positioned on second edge 102 of page protector 100.

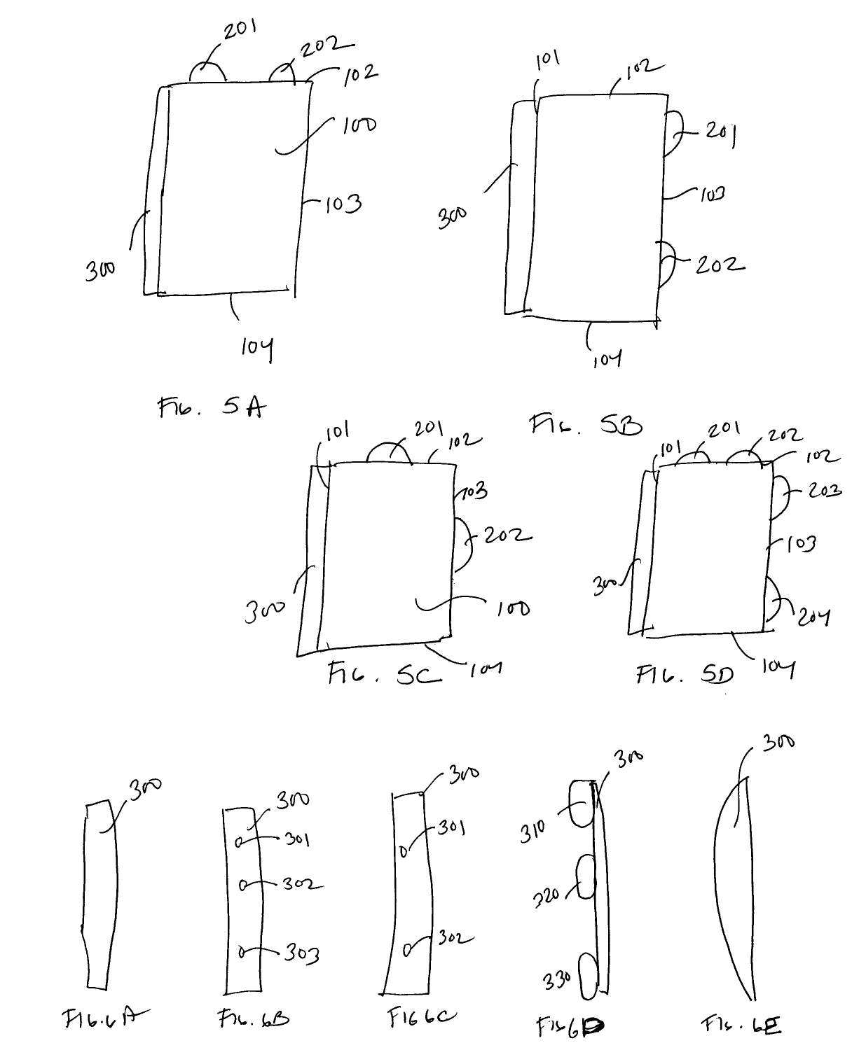

Additionally, the at least one tab 200 may be comprised of a plurality of tabs to attach to a surface. For example, FIG. 5A illustrates an embodiment wherein the at least one tab 200 is comprised of a first tab 201 and a second tab 202. First tab 201 and second tab 202 are attached to second edge 102 of page protector 100. FIG. 5B illustrates another embodiment wherein the at least one tab 200 is comprise of a first tab 201 and a second tab 202 wherein first tab 201 and second tab 202 are attached to third edge 103 of page protector 100.

In some embodiments of the present invention, the at least one tab 200 may be positioned on both first edge 101 and third edge 103 which allows users to hang a page in either the portrait or landscape orientation. For example, FIG. 5C illustrates an embodiment wherein first tab 201 is attached to second edge 102 and second tab 202 is attached to third edge 103.

FIG. 5D illustrates an embodiment of the present invention which also allows both portrait or landscape orientation and is comprised of a plurality of tabs. In the embodiment of the invention shown in FIG. 5D, the at least one tab 200 is comprised of a first tab 201, a second tab 202, a third tab 203, and a fourth tab 204 wherein first tab 201 and second tab 202 are attached to second edge 102, and third tab 203 and fourth tab 204 are attached to third edge 103.

The at least one tab 200 includes an element that permits attachment to a surface. In some embodiments, the at least one tab 200 may include a magnet for attachment of page protector 100 onto refrigerators, lockers, or other magnetic surfaces. Alternatively, the at least one tab 200 may include either hook or loop components typical of any standard hook and loop fastening system such as VELCRO®. For example, tab 200 may include hook components for attachment on a surface that includes loop member components or any material or fabric (such as certain carpet-like material or similar textiles) that has similar properties to a standard loop member system and that allows attachment to a hook fastening system.

In other variations of the invention, the at least one tab 200 may include an adhesive element. Any suitable adhesive known in the art may be used on the at least one tab 200. For instance, the at least one tab 200 may include adhesive methods such as double-sided sticky tape or may include an adhesive element directly thereon. Examples of adhesives that may be applied to at least one tab 200 may include liquid adhesives that comprise epoxy, acrylic, urethane, or any other suitable ingredient known in the art. For embodiments of the invention that utilize adhesive methods such as double-sided sticky tape, a possible example may include 3M™ Mounting Squares (which are double-stick foam squares that can hold up to two pounds). Such adhesive methods offer a lighter-duty adhesive solution. Although not likely necessary for most contexts and applications, 3M™ Acrylic Foam Tapes offer a more secure adhesion method for heavier duty applications. 3M™ Acrylic Foam Tapes are often used in applications that require an more secure method of attachment as they allow stress forces of an application to be dissipated throughout the foam core, providing strength; and viscoelastic properties of these tapes allow it to conform to surface irregularities and gaps which may be suitable for displaying the page protector on uneven surfaces such as ones comprised of cardboard or wood. Such methods of attachment may be suitable for heavier items (e.g., art canvases, award plaques) and/or for contexts in which the page protector contains items heavier than average pages of a document or photograph. Of course, any suitable variety of adhesives may be used with the present invention depending on the type of application, the contents of the page protector, and the weight of the items to be contained in the page protector.

Yet, in other embodiments, the at least one tab 200 may not include a separate element for attachment and may simply provide a surface area through which thumbtacks or pushpins are inserted through to attach page protector 100 to a bulletin board, wall, or any suitable surface. Tab 200 thus prevents page protector (and the contents therein) 100 from being damaged from pin holes.

In some embodiments, the at least one tab 200 may already include one or more preexisting holes through which a thumbtack or pushpin may easily be inserted therein. Such preexisting holes allows page protector 100 to be displayed not only on surfaces through which a thumbtack may be inserted such as bulletin boards, corked surfaces, and drywall, but such holes also permit the hanging of page protector from the ceiling or from other objects using a variety of strings, ribbons, chains, or other cords. In such embodiments, the at least one tab 200 may be attached on first layer 110 of page protector 100 (see e.g., FIG. 4A which is described in more detail below) and a second tab may be attached on second layer 120 of page protector 100 (which is not depicted in FIG. 4A). Alternatively, the at least one tab 200 may be attached on second layer 120 of page protector 100 (see e.g., FIG. 4B) and a second tab may be attached on first layer 110 of page protector 100 (which is not shown in FIG. 4B). In these embodiments, the second tab allows the opening 150 of page protector 100 to be closed (by inserting and tying a string, ribbon, chain or other cord through the holes of the at least one tab 200 and through the second tab) to secure the contents therein while page protector 100 is being hung from a ceiling or other surface. In embodiments of the invention which do not include preexisting holes, the holes may simply be added by hole-punching the at least one tab 200 or by threading a ribbon, chain or other cord therein.

The at least one tab 200 is detachable from page protector 100. For example, one or more series of perforations allow users to easily tear off the at least one tab 200 before the user stores and binds it away in a scrapbook, photo album, or binder. For example, in the embodiments shown in FIGS. 1A and 2, a perforation exists between tab 200 and along second edge 102, and in the embodiments shown in FIGS. 1B and 3, a perforation exists between tab 200 and along third edge 103. In the embodiments shown in FIG. 5A, perforations exist between first tab 201 and second edge 102 and between second tab 202 and second edge 102. In FIG. 5B, perforations exists between first tab 201 and third edge 103 and between second tab 202 and third edge 103. In the embodiments shown in FIG. 5C, a perforation exists between first tab 201 and second edge 102 and between second tab 202 and third edge 103. In the embodiments depicted in FIG. 5D, perforations exist between first tab 201 and second edge 102 and between second tab 202 and second edge 102, and perforations exist between third tab 203 and third edge 103 and between fourth tab 204 and third edge 103.

By removing the at least one tab 200, the user has a page protector 200 with clean edges with no adhesive, magnets, or holes thereon to display in their scrapbook, photo album, or binder for later viewing or reference. In embodiments of the invention wherein tab 200 is removable via perforations positioned between tab 200 and an edge of page protector 100 and in embodiments of the invention that do not include perforations between tab 200 and an edge of page protector 100, the at least one tab 200 can also be cut off by scissors for a cleaner edge. However, it is not necessary to detach the at least one tab 200 as the user may want to later display the page protector for later applications or may simply not mind having that at least one tab 200 projecting from page protector 100.

Page Protector

As depicted in FIGS. 1A, 1B, 2, 3, and 5A-5D, page protector 100 includes a first edge 101, a second edge 102, a third edge 103, and a fourth edge 104. Binding member 300 is attached to first edge 101. FIGS. 4A and 4B depict a cross-sectional view along second edge 102 of a page display and organizer in accordance with an embodiment of the present invention. Binding member 300 is attached along first edge 101. As shown in FIGS. 4A and 4B, page protector 100 also includes a first layer 110 and a second layer 120 that is connected to one another by first edge 101, third edge 103, and fourth edge 104 (fourth edge 104 is not shown in cross sectional view shown in FIGS. 4A and 4B). In an alternate embodiment of the present invention (not illustrated), first layer 110 and second layer 120 may be connected via first edge 101, second edge 102, and fourth edge 104 and opening 105 would be positioned along third edge 103.

As seen in FIGS. 4A and 4B, page protector 100 further includes an opening 150 along second edge 102 for insertion of a page therein, wherein opening 150 is formed by first layer 110 and second layer 120 of page protector 100. In FIG. 4A, the at least one tab 200 is may be attached along the surface of first layer 110. Alternatively, as shown in FIG. 4B, the at least one tab 200 may be attached along the surface of second layer 120.

Page protector 100 is transparent to allow displaying and viewing of the contents therein and is made of a material comprising of plastic. In certain embodiments, page protector 100 is made with archival quality and is acid free to preserve and protect the contents therein. Additionally, the materials used for page protector 100 is ideally PVC free polypropylene that will not yellow, transfer ink from documents, or stick to photographs. Thus, certain embodiments of the present invention include page protector 100 made in heavyweight archival safe glass clear polypropylene for long lasting durability to both display and store the contents therein. For example, in one embodiment, page protector 100 may be made of a heavy weight 80 micron (3.15 Mil) glass clear polypropylene that is archival safe, non-toxic, odor free and environmentally safe recyclable polypropylene that will not copy, smear or damage photos, cd, dvd, laser and ink jet ink print on documents.

Page protector 100 may be of any suitable size. For example, in some embodiments page protector 100 may have dimensions of 8½ inches×11 inches to accommodate standard sized documents, and in other embodiments, page protector 100 may be have dimensions of 8½ inches×14 inches to accommodate legal-sized documents. In other embodiments, page protector 100 may be dimensioned to accommodate specific photo sizes such as: 2 inches×3 inches for mini-wallets photos, 2¼ inches×3¼ inches or 2⅓ inches×3⅓ inches for standard wallet-sized photos, 2½ inches×3½ inches for “jumbo” or traditional wallets photos, 3 inches×5 inches, 4 inches×6 inches, 5 inches×7 inches, 8 inches×10 inches, or any desired dimensions to suit a particular photograph or document size. Yet, in alternate embodiments, page protector 100 may be sized to accommodate: any standard-sized POST-ITS® such as 3 inches×3 inches or any other piece of stationery with a re-adherable strip of adhesive on the back for temporarily attachment to a variety of surfaces, any sized sheets of stationary or notecards, business cards, posters, or banners.

Binding Member

As seen in the accompanying drawings, binding member 300 is attached to first edge 101 of page protector 100. Page protector 100 is used with a binder (e.g., scrapbook, photo album, or three-hold binder) that is adapted to receive and hold page protector 100 wherein the binder can hold a plurality of page protectors. The binder may be similar to a scrapbook, photo album, or regular three-ring binder, and binding member 300 is adapted to be received by the binder. Binding member 300 may be of any suitable shape and size and may further include one or more apertures. For example, in one embodiment, binding member 300 is rectangular in shape and runs along the entire length of first edge 101 as seen in FIGS. 1A-1B and 5A-5D. In such embodiments, the binder in which page protector 100 is to be stored in simply has a binding mechanism that binds in or clips in binding member 300 thereby holding page protector 100 in place.

In another embodiment, binding member 300 may include a certain number of apertures wherein the binder includes the same number of corresponding rings to receive the holes of binding member 300. For example, as seen in FIG. 2, page protector 100 may be dimensioned to accommodate 8½ inches×11 inches documents, and binding member 300 may include a first aperture 301, a second aperture 302, and a third aperture 303 to fit into a standard three-ring binder or a scrapbook or photo album that includes a standard three-ring binding apparatus. In another example as seen in FIG. 3, binding member 300 may include a first aperture 301 and a second aperture 302 and is adapted for use for a certain scrapbook, photo album, or binder.

Binding member 300 may be of any suitable size and shape and may be positioned within any suitable location on first edge 101 of page protector 100. For example, as seen in FIG. 6A and as seen in FIGS. 1A-1B and 5A-5D, binding member 300 may be rectangular in shape and run along the entire edge of first edge 101 of page protector 100. Alternatively, binding member 300 may be rectangular-shaped but only runs along a portion of first edge 101.

As seen in FIGS. 6B and 6C and as depicted in FIGS. 2 and 3 respectively, binding member 300 may include a plurality of holes that is adapted for certain binders as discussed above. Additionally, binding member 300 may include multiple components attached to first edge 101 of page protector 100. For example, in one embodiment as shown in FIG. 6D, binding member 300 is comprised of a first binding member 310, a second binding member 320, and a third binding member 330 wherein first binding member 310, second binding member 320, and third binding member 330 are adapted to be received in a specific type of binder, scrapbook or photo album.

Furthermore, binding member 300 may be of any suitable shape. As shown in FIG. 6E, binding member 300 may include a curvature (which may or may not include one or more apertures) which is specifically adapted for use with certain binders, scrapbooks, or photo albums.

System to Display and Organize Pages

Another aspect of the present invention is directed to a system to display and organize pages comprised of: (1) a page display and organizer as described above which is comprised of a page protector, at least one tab on the page protector, and a binding member; and (2) a storage unit adapted to receive and hold the page display and organizer wherein the storage unit can hold a plurality of page display and organizers. The storage unit may be a binder similar to a scrapbook, photo album, or regular binder, and the binding member is adapted to be received by the binder. For example, in one embodiment, the binding member may include a certain number of apertures wherein the binder includes the same number of corresponding rings to receive the holes of the binding member. In such embodiments of the present invention, the page display and organizer and the binders may be sold as a unit or may be sold separately.

In one embodiment of the invention, the binding member may include either hook or loop components of a standard hook and loop fastening system such as VELCRO® and the storage unit includes the complementary hook or loop component to receive and secure the page protector. For instance, the binding member may include hook components for attachment onto a surface of the storage unit that includes loop member components or any material or fabric (such as carpet-like material or similar textiles) that has similar properties to a standard loop member system and that permits attachment to a hook fastening system. One variation of the invention is comprised of a (1) a page display and organizer comprised of a page protector, at least one tab attached to an edge of the page protector, and a binding member that includes hook components of a standard hook and loop fastening system; and (2) a storage unit adapted to receive and hold the page display and organizer wherein the storage unit can hold a plurality of page display and organizers. The storage unit is comprised of a loop fastening system (or any material or fabric such as carpet-like material or similar textile that has similar properties to a standard loop system and that permits attachment to a hook fastening system). In such embodiments of the invention, a plurality of page protectors may be attached into the storage unit (via the binding member) in any suitable configuration. In one variation of the invention, the storage unit is configured like a booklet that opens up and either the entire interior surface or the majority of the interior surface includes a loop fastening system such that the page displays may be attached anywhere via the binding member and in any configuration within the surface of the storage unit. As such, the page protectors may be staggered or layered to allow an optimum amount of page protectors to be contained within the storage unit, may be arranged in any random pattern or collage, may be lined up like a grid, or may be configured in any desired arrangement. In these variations of the invention, the booklet may include essentially one surface (i.e., the inside cover of the booklet) for page protector attachment or it may include multiple pages for even more surfaces for page protector attachment. The hook and loop fastening system allows the user to easily remove any one or more desired page protectors contained within the storage unit for later viewing and/or display.

In other variations of the invention, the hook and loop fastening system may be configured as follows: the binding member may include a loop fastening system (or any fabric such as a carpet-like material or similar textile that has similar properties to a standard loop system and that permits attachment to a hook fastening system) and the storage unit may include a hook fastening system.

In an alternate embodiment wherein the binding member includes either hook or loop components of a standard hook and loop fastening system such as VELCRO® as described above, the storage unit may be configured like a booklet or binder, but only designated surfaces of the interior surface include a loop fastening system. Alternatively, the binding member may include hook components of a standard hook and loop fastening system, and loop fastening system tape may be applied to any surface within the storage unit which may be configured like a booklet, binder, or any suitable configuration. Furthermore, in further embodiments of the invention the tab may include components of the hook and loop fastening system and may also function as the binding member by attaching the tab to the storage unit.

In other embodiments, the surface to which the page display is displayed on and the storage unit may be the same surface. For example, a user may want to display notes, POST-ITS®, and/or business cards within the user's workspace. In such embodiments, the page displays are sized to accommodate such notes or cards. The attachment tabs may include a hook fastening system, and the surface to which the page protectors are displayed include a loop fastening system (or fabric or textile with characteristics similar to a loop fastening system). The surface to which the page protector is displayed also functions as the storage unit since it may be folded like a booklet that folds into two or more sections for later storage. Thus, the user can easily unfold the booklet-like storage unit to later again display the page protectors (and its contents) therein. Since the display surface and storage unit surface to which the page protector is attached is the same surface in these embodiments of the invention, the tab which attaches to the display surface essentially also functions as the binding member since the tab also attaches directly to the storage unit, or in another view, the binding member which attaches directly to the storage unit essentially also function as the tab (i.e., as the point of attachment to the display surface).

Method of Displaying and Organizing Pages

The present invention is also directed to a method of displaying and organizing pages of a document or photographs. The method of the present invention comprises: (1) providing a page display and organizer as described above which is comprised of a page protector, at least one tab on the page protector, and a binding member; (2) inserting a page inside the page protector; (3) displaying the page protector by attaching the at least one tab onto a surface; (4) removing the page protector from the surface; (5) detaching the tab from the page protector; and (6) binding the page protector in a suitable storage unit by engaging the binding member with a suitable storage unit such as a binder to hold the page protector within the binder.

Accordingly, the user displays a page by inserting a page into the page protector via the opening within the page protector, and attaching the tab to a surface such as a refrigerator or bulletin board. The user can then store the page while still in the page protector by removing the page protector from the surface, detaching the removable tab from the page protector via a preexisting perforation or by cutting off the tab, and then binding the page protector via the binding member into an appropriate scrapbook, photo album, or any suitable binder.

Some of the actions as described in the method hereinabove may be added, omitted, modified, or performed in various sequences. Also, some of the actions identified in the embodiments described herein are for illustrative purposes, and as such, some of the actions may be modified, added, or omitted without departing from the scope of the invention.

It can be realized from the embodiments described herein that the present invention provides a page display and organizer that (a) allows documents and photographs to be displayed, (b) protects documents and photographs from damage due to sunlight, liquids, stains, wrinkling, and folding, and (c) provides an efficient way to easily and quickly store and organize such documents and photographs for later reference and viewing. The present invention addresses a need in the art as it allows for displaying while protecting the documents or photograph and avoids the arduous task of later having to organize, store and scrapbook or to place these pages into photo albums or into some other storage medium in an organized manner. It can also be realized that the present invention addresses a need in home, school, office and workplace, and retail applications and contexts.

It is to be understood that although some advantages of the present invention are described herein, it is not necessary that all the advantageous features and/or all the advantages need to be incorporated into every embodiment of the invention.

While the description above refers to particular embodiments of the present invention, it will be understood that many modifications may be made (some of which are discussed above) without departing from the spirit thereof. The presently disclosed embodiments are therefore to be considered in all respects as illustrative and not restrictive.

What is claimed is:

1. A page display and organizer comprising:
a page protector comprised of
a first edge,
a second edge,
a third edge,
a fourth edge,
a first layer and a second layer wherein the first layer is connected to the second layer along the first edge, the third edge, and the fourth edge, and
an opening along the second edge wherein the opening is formed by the first layer not being connected to the second layer along the second edge and wherein a page may be inserted through the opening into the page protector;
at least one tab adjoined to the page protector wherein the at least one tab attaches the page protector to a surface for display; and
a binding member attached to the first edge wherein the binding member binds the page protector into a storage unit.

2. The page display and organizer of claim 1 wherein the at least one tab comprises an adhesive.

3. The page display and organizer of claim 1 wherein the at least one tab comprises a magnet.

4. The page display and organizer of claim 1 wherein the at least one tab comprises a hook and loop fastening system.

5. The page display and organizer of claim 1 wherein the at least one tab comprises a perforation along the page protector wherein the perforation allows the at least one tab to be detached from the page protector.

6. The page display and organizer of claim 1 wherein the at least one tab is adjoined to the second edge of the page protector.

7. The page display and organizer of claim 1 wherein the at least one tab is adjoined to the third edge of the page protector

8. A page display and organizer comprising:
a page protector comprised of
a first edge,
a second edge,
a third edge,
a fourth edge,
a first layer and a second layer wherein the first layer is connected to the second layer along the first edge, the third edge, and the fourth edge, and
an opening along the second edge wherein the opening is formed by the first layer not being connected to the second layer along the second edge and wherein a page may be inserted through the opening into the page protector;
a plurality of removable tabs adjoined to the page protector wherein the plurality of removable tabs attach the page protector to a surface for display; and
a binding member attached to the first edge wherein the binding member binds the page protector into a storage unit.

9. The page display and organizer of claim 8 wherein the plurality of removable tabs comprises a perforation along the page protector wherein the perforation allows the plurality of removable tabs to be detached from the page protector.

10. The page display and organizer of claim 8 wherein the plurality of removable tabs is comprised of a first tab and a second tab wherein the first tab is adjoined along the second edge of the page protector and the second tab is adjoined along the third edge of the page protector.

11. The page display and organizer of claim 8 wherein the plurality of removable tabs is comprised of a first tab and a second tab wherein the first tab and the second tab are adjoined along the second edge of the page protector.

12. The page display and organizer of claim 11 wherein the plurality of removable tabs is further comprised of a third tab and a fourth tab wherein the third tab and the fourth tab are adjoined along the third edge of the page protector.

13. A system to display and organize pages comprising:
(a) a page display and organizer comprising:
(i) a page protector comprised of
a first edge,
a second edge,
a third edge,
a fourth edge,
a first layer and a second layer wherein the first layer is connected to the second layer along the first edge, the third edge, and the fourth edge, and
an opening along the second edge wherein the opening is formed by the first layer not being connected to the second layer along the second edge and wherein a page may be inserted through the opening into the page protector;
(ii) at least one tab adjoined to the page protector wherein the at least one tab attaches the page protector to a surface for display, and
(iii) a binding member attached to the first edge; and
(b) a storage unit wherein the binding member binds the page protector into the storage unit and the storage unit is adapted to hold a plurality of page protectors.

14. The system to display and organize pages of claim 13 wherein the at least one tab comprises an adhesive.

15. The system to display and organize pages of claim 13 wherein the at least one tab comprises a magnet.

16. The system to display and organize pages of claim 13 wherein the at least one tab comprises a hook and loop fastening system.

17. The system to display and organize pages of claim 13 wherein the at least one tab comprises a perforation along the page protector wherein the perforation allows the at least one tab to be detached from the page protector.

18. The system to display and organize pages of claim 13 wherein the binding member comprises a hook and loop fastening system.

19. The system to display and organize pages of claim 13 further comprising a hook and loop fastening system wherein the binding member comprises a hook fastening component and the storage unit comprises a loop fastening component.

20. The system to display and organize pages of claim 13 wherein the binding member comprises a plurality of apertures and the storage unit is comprised of a binder comprising a quantity of rings wherein the quantity of rings is equal to the plurality of apertures.
